(19) United States
(12) Patent Application Publication
(10) Pub. No.: US 2010/0086577 A1
(43) Pub. Date: Apr. 8, 2010

(54) METHOD AND DEVICE FOR DESTRUCTION OF LICE AND LICE EGGS

(75) Inventors: Jose Alberto Munoz, Greenwich, CT (US); Michele Errico, Greenwich, CT (US)

Correspondence Address: Leason Ellis LLP, 81 Main Street, Suite 503, White Plains, NY, 10601, US

(73) Assignee: The Salon at Westchester, Inc., Scarsdale, NY (US)

(21) Appl. No.: 12/574,170

(22) Filed: Oct. 6, 2009

Related U.S. Application Data
(60) Provisional application No. 61/103,369, filed on Oct. 7, 2008.
(60) Provisional application No. 61/163,643, filed on Mar. 26, 2009.

(51) Int. Cl. A01N 65/06; A01N 25/34; A01P 15/00; A45D 24/10

(52) U.S. Cl. 424/405; 424/770; 132/148

(57) ABSTRACT

A method for treating and killing lice and lice eggs in hair of a person includes the steps of: combing and ironing the hair of the person using a hand-held flat-iron device. The flat-iron device includes a handle having a first arm and a second arm that is pivotally coupled to the first arm at first ends thereof, wherein in an open position, strands of hair are inserted between the first and second arms. The flat-iron device also includes at least one heat conducting plate that is disposed along an inner surface of one of the first and second arms. The plate is operably coupled to a source of heat for controlled heating of the plate to a temperate of at least 130° F. A first edge of the heat conducting plate extends to within 1 millimeter of a first edge of the arm on which the heat conducting plate is disposed. In a closed position, the strands of hair are pinched and held between the two arms in contact with the heated plate resulting in heat being applied to the hair including within a zone that is less than 5 millimeters from a scalp of the person.

### CROSS REFERENCE TO RELATED APPLICATION

The present application claims benefit to U.S. Patent Application Ser. No. 61/103,369, filed Oct. 7, 2008, and U.S. Patent Application Ser. No. 61/163,643, filed Mar. 26, 2009, which are hereby incorporated by reference in their entirety.

### TECHNICAL FIELD

The present invention relates to treatment of head lice and more particularly, to a device and method for treating adult lice and lice eggs using a hand-held device that combs and irons the infested hair and optionally using a natural wetting composition.

### BACKGROUND

Head lice infestation (pediculosis capitis) is a major health problem in the United States as well as many other locations across the world, including throughout Europe and Asia. Lice are external parasites of warm blooded animals. Lice spread by crowding and sharing of personal items such as combs, hats, brushes and clothing. There are different types of lice and in particular, humans are host to three different types of lice, namely, (1) head lice, (2) body lice, and (3) crab or pubic lice.

The louse has evolved in a highly specialized manner for survival on the haired human scalp, to the extent that its survival requires it to spend its entire life-cycle on a human host. The life cycle of the head louse falls into three phases, namely, egg (nit), nymph and mature louse. Louse eggs are usually laid at the base of hairs (e.g., within 5 millimeters of the scalp), where they hatch typically during day 8 to day 12. The eggs are attached by a substance to the hairs and are camouflaged by being the same color as the scalp. The nymph resembles the adult louse in behavior, and in physical teens apart from size. The nymph is mature in about ten days after hatching. Mature head lice are about 2 to 4 millimeters in length, they shun light and move very swiftly in all lateral directions. The six claw structure of the louse allows it to move very quickly and make it very hard to catch. Lice are otherwise transparent however they camouflaged themselves by darkening, after feeding, to the color of the skin and hair of the host. The empty egg-shell is called a nit. Nits are white in color and remains firmly glued to the hair.

Lice infestation is very embarrassing since many people associate lice infestation as originating from an unclean house or as being prevalent among the poor and less fortunate. However, this is not true since lice infestation is prevalent among all socio-economic classes.

There are a number of different treatment methods that are promoted as being effective against lice infestation; however, each has their own drawbacks and limitations. One recommendation is to machine wash in hot water all clothing and bedding materials, which may have contacted an infested individual. Another method is to bag all items for a two week period after which time, any presence of lice will be eradicated. Another widespread and well known method for treatment of lice infestation is the use of chemicals. Chemicals are typically divided into those that are effective against only lice and those that are effective against lice and their eggs (nits). The main problem with this method of treatment is that lice tend to build up a resistance to the specific chemicals, thereby reducing the effectiveness of the treatment. In addition, the accumulation of chemicals in the body is also not desirable.

One other method of treatment involves the use of combs for removing lice which are caught between the comb teeth when the teeth are passed through the hair. However, this approach tends to be inadequate in removing lice eggs which remain attached to the hair. Other methods include the use of combined hot air and a steam hair dryer. However, adult lice are very quick and therefore, as the comb is being applied to one location, the lice scamper and run to another location, effectively dodging the treatment.

It is also known to apply natural compositions to the scalp as a means for treating a head lice infestation. For example, certain essential oils have been used to repel and treat head lice; however, these oils are used only to treat adult head lice and are ineffective against eggs (nits).

What is needed is a comprehensive and effective treatment that eliminates not only adult lice and lice eggs.

### SUMMARY

In accordance with the present invention, a method for treating and killing lice and lice eggs in hair of a person includes the steps of: combing and ironing the hair of the person using a hand-held flat-iron device. The flat-iron device includes a handle having a first arm and a second arm that is pivotally coupled to the first arm at first ends thereof, wherein in an open position, strands of hair are inserted between the first and second arms. The flat-iron device also includes at least one heat conducting plate that is disposed along an inner surface of one of the first and second arms. The plate is operably coupled to a source of heat for controlled heating of the plate to a temperate of at least 130° F. A first edge of the heat conducting plate extends to within 1 millimeter of a first edge of the arm on which the heat conducting plate is disposed. In a closed position, the strands of hair are pinched and held between the two arms in contact with the heated plate resulting in heat being applied to the hair including within a zone that is less than 5 millimeters from a scalp of the person.

A device for destruction of lice and lice eggs includes a handle including a first arm and a second arm that is pivotally coupled to the first arm at first ends thereof. The device includes at least one heat conducting plate that is disposed along an inner surface of one of the first and second arms. The plate is operable coupled to a source of heat for controlled heating of the plate to a temperate of at least 130° F. A first edge of the heat conducting plate extends to within 1 millimeter of a first edge of the arm on which the heat conducting plate is disposed. The device further includes at least one comb structure disposed along the first edge of the arm and located adjacent but spaced from the heat conducting plate. The comb structure has teeth formed along its length.

Further aspects and features of the exemplary treatment method and device disclosed herein can be appreciated from the appended Figures and accompanying written description.

### BRIEF DESCRIPTION OF THE DRAWINGS

FIG. 1 is a perspective view of a hand-held heated device for treating lice and lice eggs by combing and ironing the infested hair; and

FIG. 2 is a side elevation view of a hand-held heated device according to another embodiment.

### DETAILED DESCRIPTION OF PREFERRED EMBODIMENTS

As described herein, the present invention is directed to a device 100 for treating head lice and lice eggs (nits) and for a method of treatment of lice infestation using the device and optionally using a natural wetting composition for wetting hair prior to heat being generated.

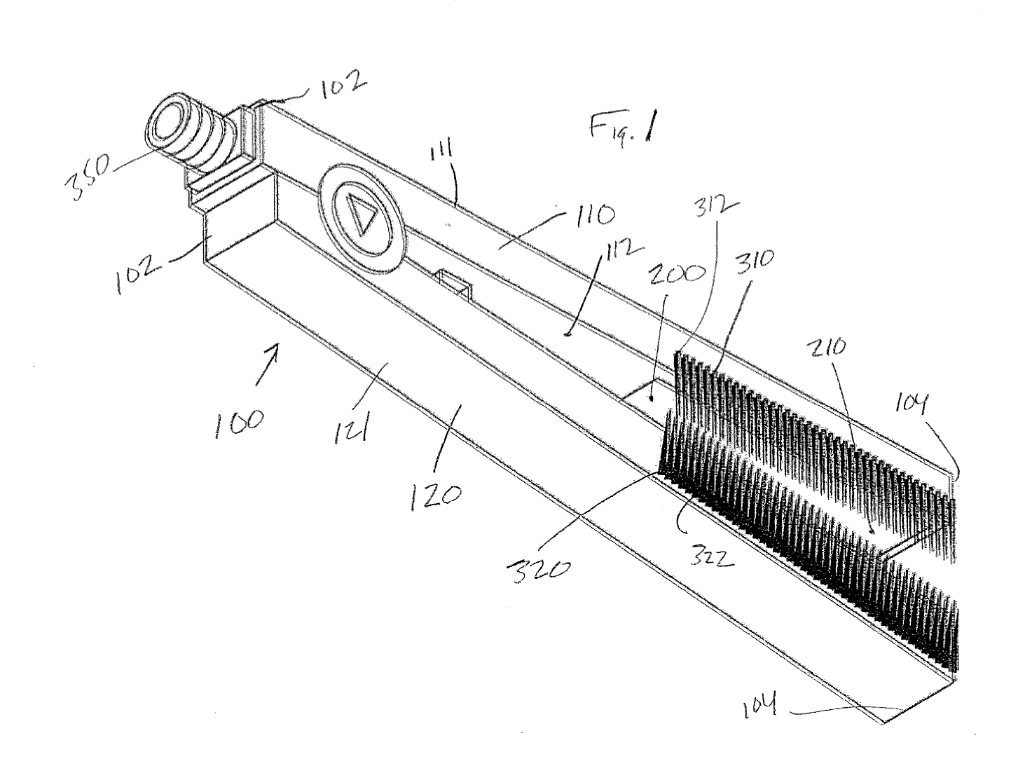

The device 100 is in the form of an elongated flat iron/curling iron that includes a first end 102 and an opposing second end 104. The device 100 includes a first arm 110 and a second arm 120 that are biased relative to one another and are pivotable relative to one another. As shown in FIG. 1, the first ends 102 of arms 110, 120 are pivotably coupled to one another, while the second ends 104 are free ends. The first and second arms 110, 120 are part of a handle assembly that is configured to be grasped by a user. The handle assembly can contain a plastic housing that houses the operative parts of the device 100.

The first and second arms 110, 120 are positioned on top of one another (stacked) and due to the arms 110, 120 being pivotally coupled to one another at one end, the arms 110, 120 resemble a scissor-like structure.

As with conventional curling irons, the device 100 includes at least one heat conducting plate 200 preferably each of the arms 110, 120 includes a heat conducting plate 200 that is disposed along an inner surface (e.g., surface 112) of one or more of the arms 110, 120. The heat conducting plate 200 is operatively coupled to a source of heat, such as a wire, that emits heat when energized. The heat conducting plate 200 is thus typically formed of a conductive member, such as a metal or ceramic, etc. The heat conducting plate 200 has an exposed outer surface 210 that faces the other arms 110, 120 and an inner surface 200 that is attached to the respective arm 110, 120. The heat conducting plates 200 can be planar in nature or they can have a slight arcuate nature. For example, the illustrated embodiment shows arms 110, 120 that have planar surfaces on which the heat conducting plates 200 are disposed; however, the arms 110, 120 themselves can have an arcuate shape and therefore, in order for the heat plates 200 to securely mate with and be attached to the arm 110, 120 in a form fitting manner, the heat conducting plates 200 themselves must have a complementary arcuate shape.

The heat conducting plates 200 are positioned on the arms 110, 120 at locations that are closer to the free second ends 104 away from where the arms 110, 120 are coupled to one another. At this location, when the arms 110, 120 are in an open position, the plates 200 are spaced from one another a sufficient distance to allow a portion of a person's hair (strands) to be inserted therebetween. The heat conducting plates 200 are also positioned opposite one another such that when the arms 110, 120 are in a fully closed position, the heat conducting plates 200 are in close proximity or even in intimate contact with one another. Heat conducting plate 200 can be a rectangular shaped structure that has a planar inner surface or face 210.

In contrast to conventional curling irons, the heat conducting plate(s) 200 of the device 100 of the present invention extends closer to a peripheral edge of the respective arm 110, 120. More specifically, conventional heat conducting plates 200 of curling irons have widths that are selected such that there is a gap or space between the sides of the heat conducting plates 200 and the peripheral edges of the arms 110, 120. This arrangement provides a measure of safety to the operator by spacing the heat conducting plates 200 away from where the operator could accidently touch, thereby burning himself/herself. This design is satisfactory for normal hair treatment, e.g., hair curling operations; however, the inclusion of such a space in the application of the present invention is not desirable since as previously mentioned, louse eggs are usually laid at the base of hairs (e.g., within 5 millimeters of the scalp) and therefore, the louse eggs would be located in this non-heated space outside of the full effects of the heat conducting plate 200. As a result, the device 100 is modified so that the peripheral edges of the heat conducting plate 200 extend closer to the peripheral edges of the arms 110, 120 and thus, when the device 100 is used, the heat conducting plate 200 is brought in closer proximity to the scalp of the person. In other words, the heat conducting plate 200 is preferably located such that when the device 100 is used, the heat conducting plate 200 is positioned within 5 millimeters of the scalp in the zone where louse eggs are located but at the same time safety and health of the patient is not jeopardized.

In yet another aspect, the device 100 can include one or more comb structures as shown in FIG. 1. The teeth size of the comb structure is selected so as to be effective at combating a lice infestation. More specifically, the comb structure 300 has fine teeth like a conventional louse comb that is intended to remove head lice nits. As previously mentioned, head lice nits are oval shaped, 0.5 mm long and 0.2 mm wide and are securely attached to the hair shaft with a strong adhesive. This natural glue makes it very difficult to remove the nits from hair. Pesticide shampoos and other treatments, as mentioned above, are intended to eradicate adult lice however, these products are not effective against removal of nits from the hair. The teeth of the comb structure have spaces or separation that are smaller than the width of nits which allows for their removal as the comb structure 300 is pulled through the hair. The length of the comb's teeth is selected for greater removal of nits and makes the comb adaptable for different lengths and types of human hair.

In the illustrated embodiment, the device 100 includes a first comb structure 310 and a second comb structure 320. The first comb structure 310 is attached to a first side edge of the arm 110, with the teeth thereof, facing downward towards the other arm 120. Edge 312 that is opposite the teeth of the comb structure 310 is preferably located close to a top face 111 of the arm 110. The first comb structure 310 can be attached to the arm 110 using conventional techniques, including bonding techniques, use of adhesives, use of fasteners, etc. The second comb structure 320 is attached to a first side edge of the arm 120, with the teeth thereof, facing upward towards the other arm 110. Edge 322 that is opposite the teeth of the comb structure 320 is preferably located close to a bottom face 121 of the arm 120. The second comb structure 320 can be attached to the arm 120 using conventional techniques, including bonding techniques, use of adhesives, use of fasteners, etc.

The teeth of the first and second comb structures 310, 320 do not mesh with one another due to the overlying nature of the arms 110, 120 and the structures of the comb structures 310, 320. Instead, the first and second comb structures 310, 320 are positioned in an adjacent relationship such that when the arms 110, 120 are placed in the closed position, the teeth of the comb structures 310, 320 overlie one another and are adjacent to one another. The teeth of each structure 310, 320 are preferably offset from one another such that when the arms 110, 120 are closed with respect to one another, the teeth of the first comb structure 110 are positioned within the space between the teeth of the second comb structure 120. The lengths of the teeth are such that when the arms 110, 120 are closed, the tips of the teeth do not interfere with the closing of the arms 110, 120. In other words, the comb structures 310, 320 are disposed in different planes when the arms 110, 120 are closed. The comb structures 310, 320 are positioned along the lengths of the arms 110, 120 such that the comb structures 310, 320 are positioned adjacent (next to) and run parallel to the respective heat conducting plate 200.

The comb structures 310, 320 can be formed of an appropriate metal or heavy grade polymer that can withstand the temperature generated by the adjacent heat conducting plate 200.

The device 100 includes a conventional power cord 350 to allow the device 100 to be attached to a power supply, such as a conventional electrical outlet.

The device 100 provides an effective tool for combating a head lice infestation since it is widely known that heat in excess of 130° F. is needed to treat the infestation. The heat conducting plate 200 has the capacity to generate heat in excess of 130° F. and actually can generate heat in excess of over 400° F. The louse eggs (nits) can be incinerated without damaging the infected person and without no long-term side effects. The device 100 is configured so that the heat conducting plate 200 is heated to a temperature of over 130° F. and therefore, when the heat conducting plate 200 is applied to the lice infected hair, termination of adult lice and nits is realized, while at the same time creating sterilized hair follicles.

Since in accordance with the present invention, the heat conducting plate 200 is positioned closer to the peripheral edge of the arms 110, 120, when hair is inserted between the arms 110, 120 as described below, and the arms 110, 120 are positioned near the scalp, the heat conducting plate 200 is positioned very close to the scalp and within the region where louse eggs (nits) are located.

In one embodiment, the device 100 is combined with a wetting product as part of the treatment process. For example, the wetting product can be a natural composition which is effective as an insecticide or it can be water that can be used to generate hot steam. Each of these solutions is intended to be applied on the hair.

For example, a natural insecticide can be used and placed in the person's hair prior to the application of the device 100 to the hair to cause heating of the hair. One particularly effective natural insecticide is cedar oil and in particular, a natural product with >1% active ingredient (cedar oil) and 99% saline solution can be used (e.g., an 8% cedar oil and 92% saline mixture). One exemplary cedar product that can be used is cedar oil that is commercially available from CedarCide Industries, Inc. of Spring, Tex. All insects breathe through their bodies and when the insects are exposed to the fumes of CedarCide, the insects are quickly overwhelmed and the mental faculties of the insects are impaired and ultimately results in death of the insects. The natural composition (cedar oil) penetrates the exoskeletons of the insect (lice) and results in death of the adult lice. The solution of cedar oil also aides in dissolving the nit bond that attaches to the hair shaft, thereby promoting the detachment of the nit from the hair.

One will appreciate that instead of using cedar oil, other natural ingredients can be substituted for the cedar oil. For example, teatree oil or lavender oil can be used. In the event that the user does not or can not use the cedar oil compound or another natural oil due to allergies, than the person can use the method disclosed herein to delouse the hair with water. When exposed to the heat generated by the one or more heat plates 200, the water vaporizes and the intense heat of over 130° F. will kill the lice and sterilize that portion of hair instantly.

One other benefit of using the CedarCide product is that the cedar oil is a natural detangular in that when applied to hair, the hair becomes easier to comb and does not tangle as easily.

In accordance with the present invention, a method is provided for treating a head lice infestation and in particular, for treating and eradicating both adult lice and nits (louse eggs). A treatment starting point is first selected on the subject's head and then the technician works towards an opposite point taking section that are small enough to comb through and iron. For example, a good starting point is at the nape of the neck and then the technician works progressively upwards toward the top of the head. In addition, the left side should be balanced with the right side so that the accent is as even as possible. Once the technician is at the top of the head, the technician can then work his/her way from the back towards the front. Case study results show that infested patients have the lice moving towards the front top of the forehead and trying to get off the host as quickly as the lice can. In some cases, the lice move so quickly it gives the appearance that the lice are jumping off the host.

Applicant has found that the combination of the device 100 with a wetting solution, such as those described herein, provides superior results. The use of a natural insecticide, such as cedar oil, kills the adult lice present in the hair, while the use of the specially configured device 100 serves to kill the louse eggs that are present close to the scalp due to the high temperature heat plate 200. This combination is particularly effective since the application of either step by itself does not completely eradicate the infestation due to the limitations of each step.

The device 100 can be marketed as a kit in that the kit can contain the device 100 along with a container of cedar oil (e.g. 4 oz bottle) and appropriate instructions. The kit can be packaged in an attractive box or other type of container. The kit can also contain a number of other accessories including but not limited to gloves, a comb for combing the hair post-treatment, a clip to hold the hair in a set position while performing the treatment, and orange sticks to check and separate hair during the treatment.

In yet another embodiment, the first and second comb structures 310, 320 can be interchangeably coupled to the device 100 to permit removal of the comb structures 310, 320. For example, comb structures 310, 320 having different teeth characteristics (e.g., shape, width, spacing, etc.) can be selected depending upon the specific application at hand. For example, a particular hair type may require one type of comb structure 310, 320, while a different hair type may require another type of comb structure 310, 320. This type of coupling also allows for easy cleaning of the comb structures.

The coupling between the comb structures 310, 320 and the handle (arms) of the device 100 can be accomplished using any number of conventional techniques, including a mechanical fit, such as a snap fit coupling between the parts.

It will also be appreciated that the comb structures 310, 320 protect the respective adjacent heat conducting plates 200 and prevent accidental contact with the heat conducting plates 200 from the side. An air gap on the order of 1 millimeter can be formed between the heat plate and teeth of the comb structure. This air gap serves as an insulator and protects the comb structure from heating to a temperature that if touched could cause injury.

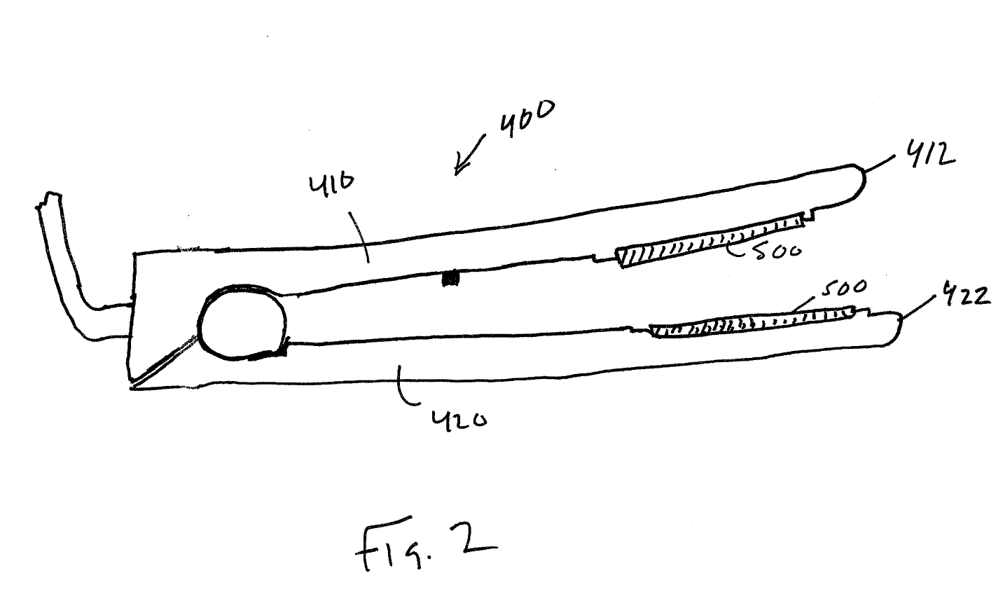

FIG. 2 illustrates another hand-held heating device 400 that is similar to device 100 and includes a pair of pivotable arms 410, 420 that each has a free end 412, 422, respectively. Each of the arms 410, 420 has a conducting plate 500 such that in the closed position of the arms 410, 420, the conducting plates 500 overlay one another and almost come or partially come into contact with one another.

In both the embodiment of FIG. 1 and FIG. 2 and others, the conducting plate is preferably heated to a temperature of between about 200° F. and about 250° F. since this range is above the heat requirement necessary to kill the lice but is below a temperature where oil is adversely impacted by the heat.

In some designs, the conducting plates 500 can be spaced slightly further than within 1 millimeter from the scalp since radial heat is emitted from the conducting plate 500 and reaches the target zone where lice eggs are found.

In yet another embodiment, the device 400 can include means to permit one or more comb structures to be removably attached to one or more of the arms 410, 420. For example, one of the parts can have a complementary channel that receives a protrusion (tabs or rails) formed on the other part in a sliding manner, thereby securely attaching the comb to the hand-held device. Combs can be easily removed for sanitization or to allow the user to select a different size. Other means for removably attaching the combs to the hand-held device can be used.

The present invention offers an effective process using a device that is known to most people but is modified for use in treating lice and lice eggs.

It will be appreciated by persons skilled in the art that the present invention is not limited to the embodiments described thus far with reference to the accompanying drawings; rather the present invention is limited only by the following claims.

What is claimed is:

1. A device for destruction of lice and lice eggs comprising:
a handle including a first arm and a second arm that is pivotally coupled to the first arm at first ends thereof;
at least one heat conducting plate that is disposed along an inner surface of one of the first and second arms, the plate being operably coupled to a source of heat for controlled heating of the plate to a temperate of at least 130° F., wherein a first edge of the heat conducting plate extends to within 1 millimeter of a first edge of the arm on which the heat conducting plate is disposed; and
at least one comb structure disposed along the first edge of the arm and located adjacent but spaced from the heat conducting plate, the comb structure having teeth formed along its length.

2. The device of claim 1, wherein the device comprises a flat iron that includes a grip portion formed along the handle to allow the device to be grasped, the first and second arms moving between an open position where second ends of the arms are spaced apart a sufficient distance to allow hair to be inserted therein and a closed position where the first and second arms are located a minimum distance from one another and where hair is pinched and grasped between the arms.

3. The device of claim 1, wherein the inner surface of the arm is a planar surface and the heat conducting plate comprises a flat rectangular shaped plate.

4. The device of claim 1, wherein there are two heat conducting plates, one disposed on the inner surface of the first arm and the other disposed on an inner surface of the second arm, the two heat conducting plates facing one another.

5. The device of claim 4, wherein the inner surfaces are curved surfaces and the heat conducting plates have curved shapes.

6. The device of claim 4, wherein there are two comb structures, one comb structure disposed along the first edge of the arm, the other disposed along a first edge of the other arm, the two comb structures being offset from one another such that in a closed position, the comb structures are located adjacent one another with the teeth of the two comb structures overlying one another with spaces being formed therebetween through which hair can pass.

7. The device of claim 1, wherein the heat conductive plate is located off-centered with respect to the inner surface and more particularly, is located closer to the first edge than an opposite second edge of the arm.

8. A package for destruction of lice and lice eggs comprising:
a hand-held heat generating device including:
a handle including a first arm and a second arm that is pivotally coupled to the first arm at first ends thereof;
at least one heat conducting plate that is disposed along an inner surface of one of the first and second arms, the plate being operably coupled to a source of heat for controlled heating of the plate to a temperate of at least 130° F., wherein a first edge of the heat conducting plate extends to within 1 millimeter of a first edge of the arm on which the heat conducting plate is disposed;
at least one comb structure disposed along the first edge of the arm and located adjacent but spaced from the heat conducting plate, the comb structure having teeth formed along its length; and
a container of a natural insecticide; and
instructions for use of the hand-held heat generating device and the natural insecticide in the treatment for destruction of lice and lice eggs in an infested person, wherein the instructions directs the application of the natural insecticide to the hair and then combing through and ironing sections of the hair using the hand-held heat generating device.

9. The package of claim 8, wherein the instructions direct that a starting point be at the nape of a neck of a patient and the combing and ironing then proceeds towards a front of a head of the person.

10. The package of claim 8, further including at least one of a comb, a hair clip and sticks for inspecting and separating strands of hair.

11. The package of claim 8, wherein the natural insecticide comprises a solution including cedar oil.

12. A method for treating and killing lice and lice eggs in hair of a person comprising the steps of:
ironing the hair of the person using a hand-held flat-iron device that includes:
a handle including a first arm and a second arm that is pivotally coupled to the first arm at first ends thereof, wherein in an open position, strands of hair are inserted between the first and second arms;
at least one heat conducting plate that is disposed along an inner surface of one of the first and second arms, the plate being operably coupled to a source of heat for controlled heating of the plate to a temperate of at least 130° F., wherein a first edge of the heat conducting plate extends to within 1 millimeter of a first edge of the arm on which the heat conducting plate is disposed, wherein in a closed position, the strands of hair are pinched and held between the two arms in contact with the heated plate resulting in heat being applied to the hair including within a zone that is less than 5 millimeters from a scalp of the person.

13. The method of claim 12, further including the steps of applying a solution of natural insecticide to the hair prior to the step of combing and ironing the hair, the solution including cedar oil.

14. The method of claim 12, further including the step of ironing the hair comprises the steps of clamping the hair at a location near the nape of a neck of the person and pulling the hair through the closed arms as the hand-held device is pulled outwards from a scalp.

15. The method of claim 14, further including the step of successively grasping new strands of hair and combing and ironing the new strands of hair and moving in a back to front direction across the head.

16. The method of claim 12, further including the steps of applying water to the hair prior to the step of combing and ironing the hair, thereby allowing steam to be generated when wetted hair is heated with the heated plate.

17. The method of claim 12, wherein the hand-held device includes two comb structures, one comb structure disposed along the first edge of the arm, the other disposed along a first edge of the other arm, the two comb structures being offset from one another such that in a closed position, the comb structures are located adjacent one another with the teeth of the two comb structures overlying one another with spaces being formed therebetween through which hair can pass.

18. The method of claim 17, further including the step of combing the hair by clamping the hair at a location near the nape of a neck of the person and pulling the hair through the closed arms as the hand-held device is pulled outwards from a scalp of the person.
